(19) United States
(12) Patent Application Publication
(10) Pub. No.: US 2004/0074350 A1
(43) Pub. Date: Apr. 22, 2004

(54) Paper pipe-cutting apparatus and cutting method using the same

(75) Inventor: Yoshikazu Hanada, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/606,210

(22) Filed: Jun. 26, 2003

(30) Foreign Application Priority Data
Jun. 28, 2002 (JP) 2002-189833

(51) Int. Cl. B23B 3/00

(52) U.S. Cl. 82/1.11; 82/113

(57) ABSTRACT

Disclosed is an apparatus for cutting a paper pipe, wherein a paper pipe is cut while rotating both a cutting blade and the long paper pipe in opposite directions to each other, in such a manner that rotational linear velocities of a cutting portion of the cutting blade and a central portion in a thicknesswise direction of the paper pipe are controlled to be within certain range. Cutting is performed while controlling the degree of vertical incision of the cutting portion.

### CROSS-REFERENCE TO RELATED APPLICATION

This application claims priority under 35 USC 119 from Japanese patent application, No. 2002-189833, the disclosure of which is incorporated by reference herein.

### BACKGROUND OF THE INVENTION

1. Field of the Invention

The present invention relates to an apparatus for cutting a cylindrical paper pipe serving as a core, around which a long recording material is wound in layers wherein a pipe is to cut to an appropriate predetermined length in a widthwise direction, perpendicular to a winding direction of the recording material. Further the invention relates to a cutting method using the cutting apparatus.

2. Description of the Related Art

Conventionally, a long recording material is wound around a cylindrical core until its thickness reaches a core diameter so as to be manufactured and shipped to be a roll as a product unit.

A thick cylindrical paper pipe is utilized as a roll's core, which is formed by winding and laminating a paper sheet around the pipe with laminated layers and applying an adhesive between the layers. Recording materials have various dimensions in width, hence an axial length of the paper pipe core may be determined so as to conform to those width dimensions.

Accordingly, a paper pipe having a relating long axial length is formed by using a paper pipe cutting apparatus, which cuts the paper pipe in a direction perpendicular to an axial direction, in conformity with the width dimensions of the recording material.

In the paper cutting apparatus, a cutting mandrel is inserted into the paper pipe, which is placed in a proper predetermined position, so that the outer periphery of the cutting mandrel comes into contact with the inner periphery of the paper pipe. Further, a non-rotatable cutting blade is positioned at the outer periphery of the paper pipe, its position corresponding to that of the cutting mandrel. The paper pipe is cut by contacting the cutting blade to the outer periphery of the paper pipe while rotating only the paper pipe at high speed.

Upon completion of the cutting, the cutting blade returns to its original position and repeats the cutting operation after being moved incrementally, in the axial direction of the paper pipe, so that the paper pipe can be maintained on the cutting mandrel while being cut into pieces axially, thus producing short paper pipes after the cutting mandrel is withdrawn.

Recently, information regarding the recording material, which is wound around the paper pipe core, is often provided on an end surface of the paper pipe (a ring-shoed thick portion). This information is recorded as machine-readable information, such as a bar code, so to aid in automatic processing in an image processing apparatus using the roll paper.

The end surface of the paper pipe, however, is a portion against which the cutting blade chafes during the cutting process, so that heat is generated by the friction therebetween (i.e., an ironing effect). Accordingly, an adhesive applied to forming the paper pipe can melt and solidify onto the end surface of the paper pipe, and due to heating of the paper pipe, the pipe itself can chemically changed such that it has a smooth glossy surface. This causes a problem in that ink adhesiveness is degraded, thus making consistent and reliable printing of information on the end surface difficult.

### SUMMARY OF THE INVENTION

Considering the above-mentioned fact, the present invention has been made to solve the above problem occurring in the prior art, and an object of the present invention is to provide an apparatus and a method for cutting a paper pipe, wherein, even upon cutting of the paper pipe, a permeability of ink for recording information to a cut face of the paper pipe is maintained and an recording is certainly secured.

A first aspect of the present invention relates to an apparatus for cutting a cylindrical paper pipe serving as a core, around which a long recording material is wound successively, in width direction perpendicular to winding direction of the recording material in a proper length.

The apparatus comprises a cutting mandrel, which is inserted into the paper pipe such that its outer peripheral face becomes in contact with an inner face of the paper pipe; a disc-shaped cutting blade placed opposite to the outer periphery of the paper pipe and having a cutting edge at its circumference; a ring-shaped groove axially provided on the cutting mandrel corresponding to a cutting position of the cutting blade; a rotating device for rotating the paper pipe as supported by the cutting mandrel; and a cutting blade rotating device for rotating the cutting blade. In this apparatus, difference between linear velocities of the paper pipe rotating device and the cutting blade rotating device is controlled within certain range.

According to the first aspect of the present invention, difference between linear velocities of the paper pipe rotating device and the cutting blade rotating device is controlled within certain range, so that relative rotation between the paper pipe and the cutting blade is nearly removed and the cutting blade is substantially forced into the paper pipe to cut. Accordingly, it prevents for the cutting blade from rubbing the cut face of the paper pipe and reduces the generation of frictional heat. With the reduction of frictional heat, an adhesive applied between thin paper sheets wound around a core for forming a paper pipe is not melted and solidified on the cut face of the paper pipe, certainly maintaining ink to permeate the cut face upon recording during subsequent process.

The apparatus according to one aspect of the present invention further may have a rotating device for rotating the cutting mandrel. The linear velocity controller preferably controls that respective rotational linear velocity by the cutting mandrel rotating device, the paper pipe rotating device and cutting blade rotating device is within certain range.

In this case, in addition to applying rotational linear velocities of the paper pipe and the cutting blade within certain range (almost constant velocity), applying rotational linear velocity of the cutting mandrel within certain range, allows relative rotation between the cutting blade and the cutting mandrel, and damage of cutting blade to be reduced.

Also, the paper pipe rotating device and the cutting mandrel rotating device may be rotated by same driving source. In this case, since the cutting mandrel and paper pipe are coaxial, they are easily rotated by same driving source, which contributes for simplification of the driving source.

The apparatus according to the first aspect of the present invention may further have a pair of rotating members positioned opposite to each other to both cutting faces of the paper pipe cut by the cutting blade, one rotating member rotating in opposite direction relative to that of the other one, and having a tapered cutting surface for cutting and removing a burr formed on an inner periphery.

In this case, the difference of relative rotation between the cutting blade and the paper pipe is reduced so as to remove the burr generated during cutting. The cutting mandrel can be easily drawn from the paper pipe. Still remained burr is trimmed off as quality control of the product. In this case, the tapered cutting surfaces becomes to be in contact with both cutting faces and are rotated contrary to each other, certainly smoothing the paper pipe without holding it.

A second aspect of the present invention relates to a method for cutting a cylindrical paper pipe serving as a core, around which a long recording material is wound successively, in width direction perpendicular to winding direction of the recording material in a proper length.

In the method, when the disc-shaped cutting blade is rotated to cut the paper pipe at certain axial position of the paper pipe, in a state that the cutting mandrel is inserted into the paper pipe with the inner periphery of the paper pipe contacted with the outer periphery of the cutting mandrel, the paper pipe is rotated to be cut while the difference between rotational linear velocities of the paper pipe and the cutting blade is controlled within certain range.

Typically, the paper pipe is rotated at low speed by one-revolution to be cut while the cutting blade is rotated at high speed. According to the second aspect of the present invention, in order to reduce frictional heat generated on the cutting face, the paper pipe is rotated to be cut while the difference between rotational linear velocities of the paper pipe and the cutting blade is controlled within certain range. Accordingly, an adhesive is prevented from being melted and coated on the cutting face, improving viscosity of ink during subsequent process.

According to the method of the present invention, in order to avoid an interference of a cutting edge of the cutting blade with the cutting mandrel upon cutting, a ring-shaped groove is preferably formed at proper position on the cutting mandrel corresponding to the cutting blade. The inner periphery of the paper pipe and the outer periphery of the cutting mandrel are in contact with each other when the paper pipe is cut with the cutting blade. The blade tip of the cutting blade contacts the cutting mandrel and the blade tip may break. Accordingly, the ring-shaped groove formed corresponding to a cutting position of the cutting mandrel may serve as a receiving groove for the cutting blade.

### BRIEF DESCRIPTION OF THE DRAWINGS

FIG. 1 is a schematic view illustrating a process for manufacturing a paper roll according to an embodiment of the present invention;

FIG. 2 is an enlarged view showing a smoothing process of a paper pipe according to one embodiment of the present invention;

FIG. 3 is a schematic perspective view showing an apparatus for cutting a paper pipe according to one embodiment of the present invention;

FIG. 4 is a front view of a main stage of the apparatus of FIG. 3 according to one embodiment of the present invention;

FIG. 5 is a perspective view showing the apparatus of FIG. 3 during operation;

FIG. 6 is a cross-sectional diagram of the paper pipe illustrating a perpendicular view from an axial perspective of the paper pipe when the pipe is cut with a cutting blade;

FIG. 7 is a cross-sectional diagram illustrating the paper pipe from an axial perspective when the pipe is cut with the cutting blade;

FIG. 8 is a front view of a structure of a cutting mandrel; and

FIG. 9 is a schematic view illustrating the details of an information writing process.

### DETAILED DESCRIPTION OF THE INVENTION

Hereinafter, a paper pipe cutting apparatus of an embodiment of the present invention will be described with reference to the accompanying drawings. The apparatus to be described is adapted to a cutting process for a paper pipe for roll paper. This manufacturing process will be described in detail later.

Manufacturing Process of Roll Paper

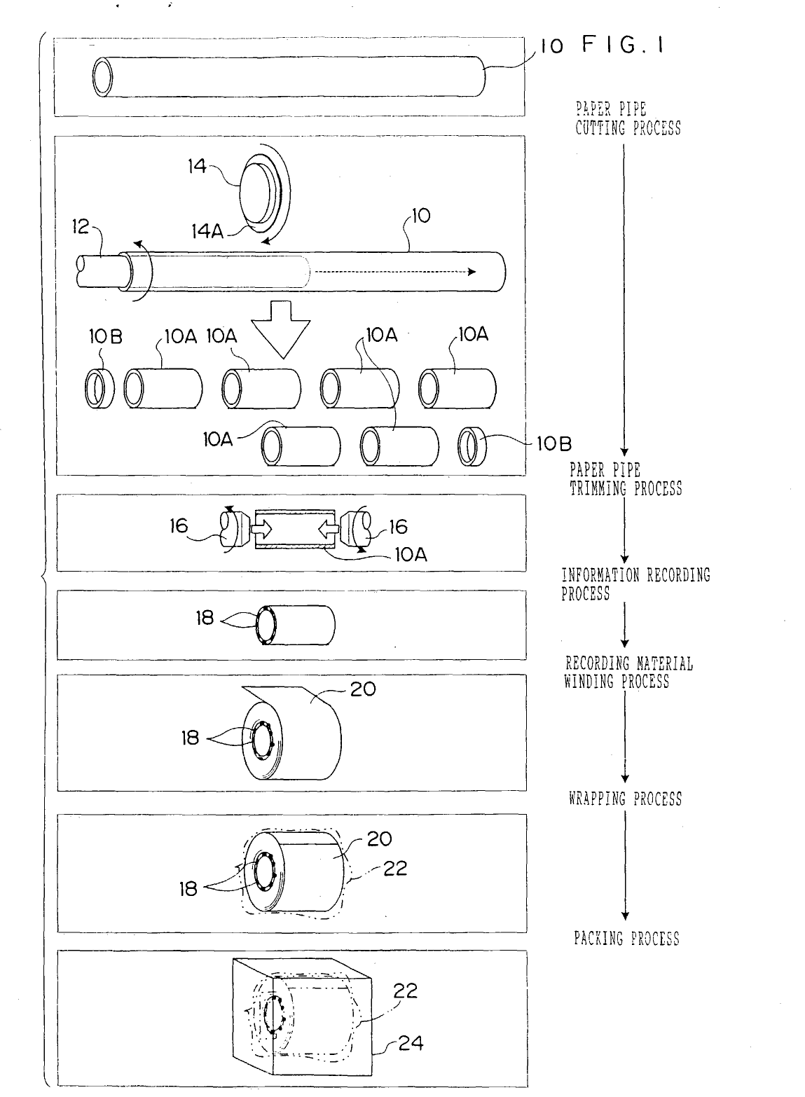

FIG. 1 is a schematic view showing a manufacturing process for a roll of paper according to one embodiment of the present invention. A long paper pipe 10 is provided and cut at certain pitches in a cutting process. In this cutting process, a cutting mandrel 12 is closely inserted into the long paper pipe 10. The paper pipe is then cut at each position at certain pitches where a cutting blade 14 is moved in an axial direction of the long paper pipe 10. Both ends 10B of the paper pipe 10 are disposed of and the remaining middle portions of the long paper pipe cut into a plurality of short paper pipes 10A are adapted as cores. After the cutting process, since burrs are generated on an inner periphery end surface of the paper pipe 10A, the burrs are removed in a smoothing process of the paper pipe.

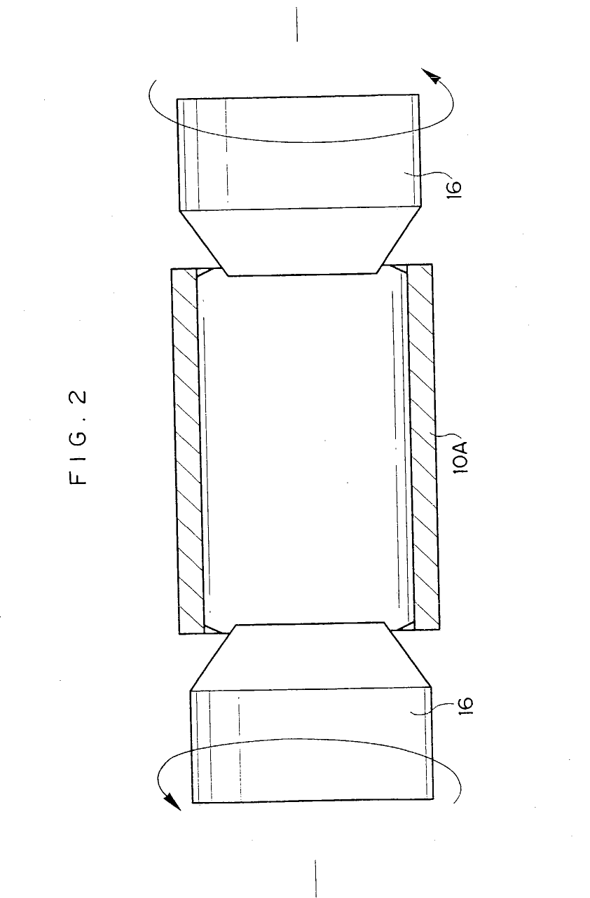

As shown in FIG. 2, the burrs are removed by a pair of rotating members 16, which have tapered cutting surfaces, positioned coaxially with the paper pipe 10A at both ends of the paper pipe 10A and rotating in opposite directions relative to each other. A cutting edge for cutting the burr is embedded in the tapered cutting edge.

The burr-free paper pipe 10A is transferred to an information writing process section where information is printed on an end portion of the paper pipe 10A (a thick portion). The information is printed in the form of a machine-readable bar code 18 includes information pertaining to type, size and others of a recording material which is wound around the paper pipe 10A in the subsequent process. In FIG. 1, the bar code 18 is printed on the base color of the paper pipe 10A. Practically, in order to eliminate the difference of shading of color, a type of ink, which does not absorb infrared rays, is often applied as the base color. This ink is applied thereon for the bar code 18.

In the information recording process after the bar code 18 is printed, a recording material 20 is wound successively around the paper pipe 10A, which acts as a core. During the subsequent wrapping process, the recording material 20 of predetermined length wound around the paper pipe is wrapped in a light-shielding wrapping paper. Further, after wrapping, a virtual vacuum is formed inside the roll of paper.

The wrapped rolled recording material 20 is packed via a packing process into a corrugated cardboard 24, and the product is then shipped.

Construction of Apparatus for Cutting Paper Pipe

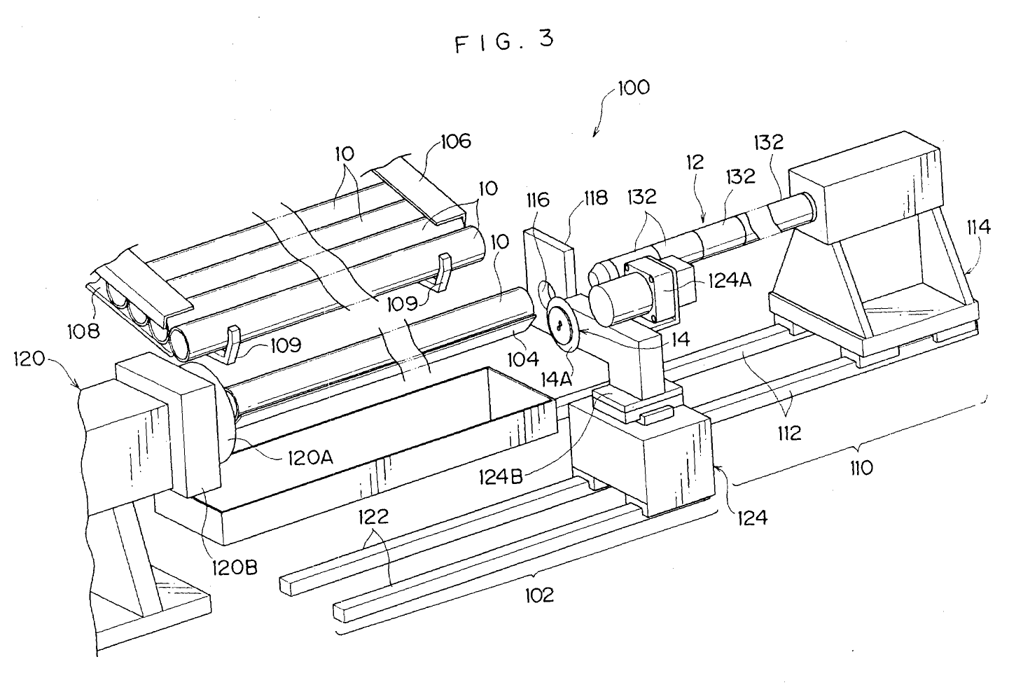

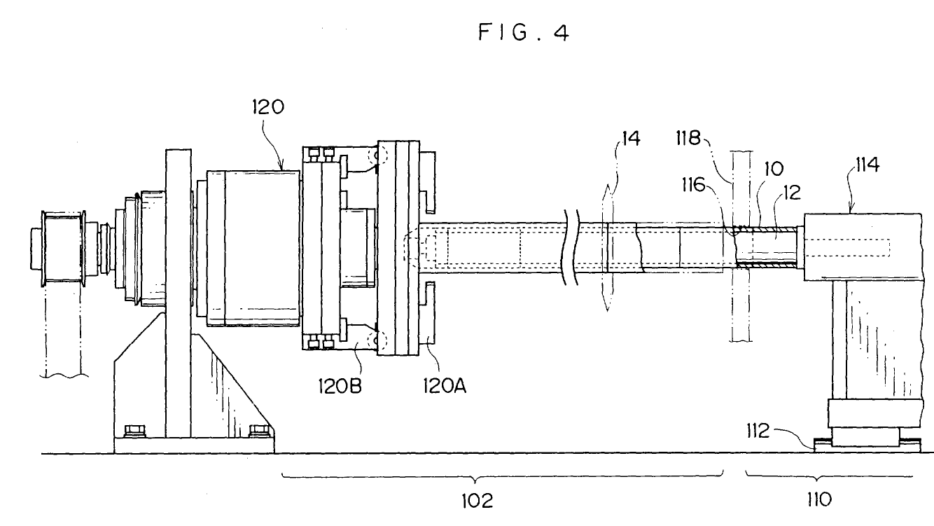

An apparatus 100 for cutting a paper pipe according to one embodiment of the present invention is shown in FIGS. 3 to 5. A supporting portion 104 for supporting a long paper pipe 10 is formed on a main stage 102 of the apparatus 100. The supporting portion is formed with V-shaped portion, on which, at two points, the long paper pipe 10 is supported.

The V-shaped portion of the supporting portion 104 has constant angle. Upon supporting the long paper pipe 10, the paper pipe is supported in such a way that a position perpendicular to axial direction of the paper pipe is maintained and supported at same position constantly.

A stock unit 106 is provided towards the main stage 102 in order to store the plural long paper pipes 10. Between the stock unit 106 and the supporting portion 104 of the main stage 102, a slope 108 is installed, along which the long paper pipes are rolled and moved from the stock unit 106 to the supporting portion 104.

Also, a stopper 109 is installed at a stock unit-side end of the slope 108. By opening and closing operation of the stopper 109, the long paper pipes 10 are transferred to the supporting portion 104 one by one.

A standby stage 110 is mounted as an annex to the main stage 102. The standby stage 110 includes a rail section 112 and a carrier 114 supported thereto. The carrier 114 is guided along the rail section 112, so that the stand-by stage 110 can be moved toward or away from the main stage 110.

A cylindrical cutting mandrel 12 is attached to the carrier 114 in such a way that its one end (an end far away from the main stage 102) is suspended and supported by the carrier 114 at one side.

The cutting mandrel 12 is placed coaxially with the long paper pipes 10 supported on the supporting portion 102 of the main stage 102. The cutting mandrel 12 has an outer diameter nearly similar to an inner diameter of the long paper pipe 10 within certain dimensional tolerance. That is, there is a state that the carrier 114 is on standby in the standby stage 102 at the farthest away from the main stage 110 and the long paper pipe 10 is moved from the stock unit 106 and is supported by the supporting portion 104. During this state, when the carrier 114 is moved in a direction of the main stage 102 along the rail section 112, the cutting mandrel 12 is accordingly axially moved and inserted into the long paper pipe 10, whereby the cutting mandrel 12 is inserted into the paper pipe 10.

A partition wall 118 having a through-hole 116 is vertically installed between the main stage 102 and the standby stage 110 and the cutting mandrel 12 is moved through the through-hole 116. At this state, the long paper pipe 10 appears to be replaced by the cutting mandrel 12 from the supporting portion 104.

At an end portion of the main stage 102 opposite to the standby stage 110, a driving chuck unit 120 is placed. The driving chuck unit 120 includes a holder section 120A for sustaining an end of the paper pipe 10 and a leading edge in moving direction of the cutting mandrel 12 moving from the standby stage 110.

The holder section 120A of the driving chuck unit 120 is rotatably provided so as to axially rotate the sustained cutting mandrel 12 and the paper pipe 10 using a rotating force by a driving section 120B. The cutting mandrel 12 and the long paper pipe 10 may be rotated at certain rotational speed by the driving force of the driving section 120B.

A rail section 122 is mounted at the main stage 102 from the standby stage 110 to the driving chuck unit 120, and a cutting unit 124 is supported on the rail section. The cutting unit 124 is possibly guided and moved from the standby stage 110 to the driving chuck unit 120 along the rail section 122.

A disc-shaped cutting blade 12 is mounted to the cutting unit 124. The cutting blade 14 has a cutting edge 14A along the whole circumference, the cutting edge being ground sharply.

The cutting blade 14 has a rotational axis coaxial with the cutting mandrel 12 and the long paper pipe 10 and is rotated at certain rotational speed by a driving force of a driving section 124A.

A carriage 124B is installed to the cutting unit 124 so as to radially move the cutting blade 14 toward or away from the long paper pipe 10 supported by the cutting mandrel 12. Accordingly, the long paper pipe 10 is cut at its outer circumference while the rotating cutting blade approaches the long paper pipe 10.

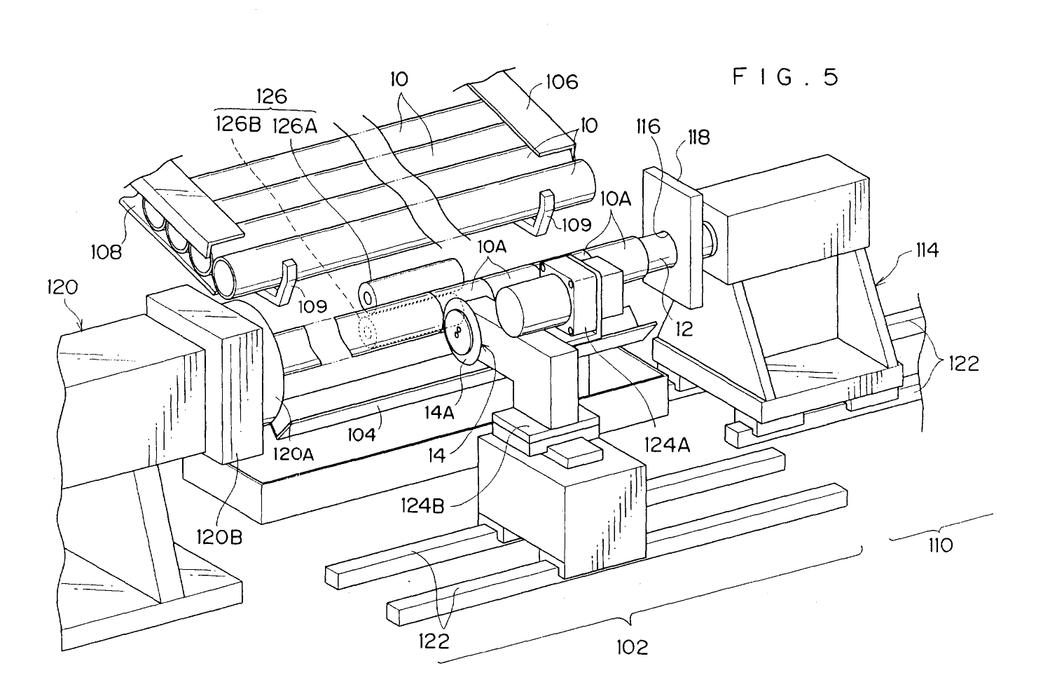

As shown in FIG. 5, pressing rollers (which consists of a pair of rollers 126A and 126B) for maintaining a position of the long paper pipe 10 upon cutting the paper pipe are provided opposite to the cutting blade 14 so as to press the long paper pipe 10 with the approach of the cutting blade 14.

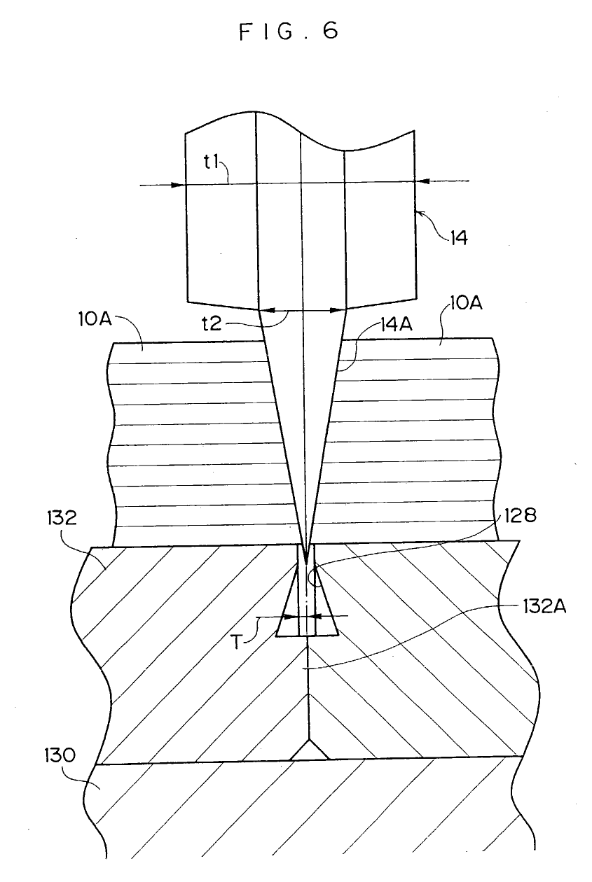

As shown in FIG. 6, the cutting blade 14 is formed such that a thickness t1 thereof from a central axis to a certain radial length is far thicker than a thickness t2 of circumference forming the cutting edge 14A (which corresponds to a root portion of the cutting edge 14A). That is, since if the rotating cutting blade 14 deviates in a thickness direction during rotating of the cutting blade 14, a cutting range can be widen during cutting of the long paper pipe 10, the thickness serves as a counter (spindle) to prevent the deviation and to stabilize rotation. Also, the circumference is formed such that, upon cutting of the long paper pipe 10, only an inserted portion (gradually sharpened portion from the thickness t2) of the cutting blade into the paper pipe is formed thinly so as to minimize the cutting range.

In this case, when the cutting blade 14 approaches the long paper pipe 10 while being rotated at certain rotation speed, the long paper pipe 10 and the cutting mandrel are also rotated at certain rotation speed.

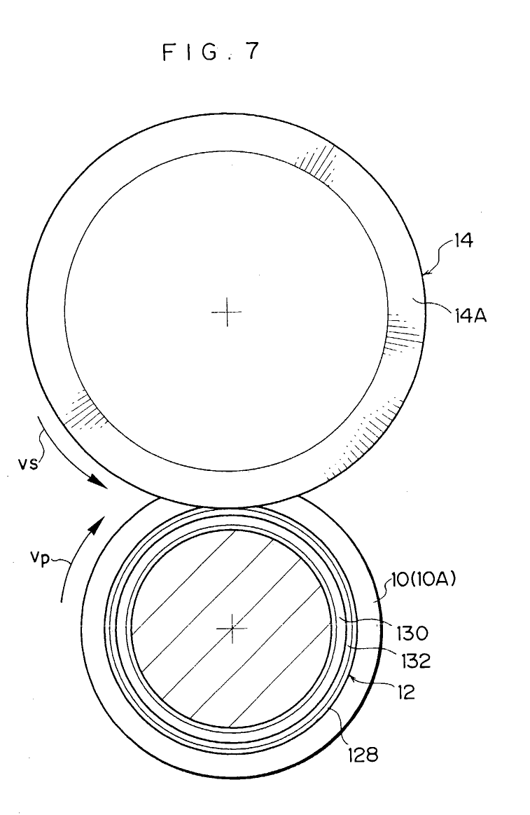

At this time, as shown in FIG. 7, respective rotational speed is controlled in such a manner that the rotational linear velocity vs of the cutting blade 14 is almost equal (difference between velocities is within certain range) to that vp of the long paper pipe 10. Also, rotational directions thereof are opposite to each other, so that one rotation may not interfere with the other rotation, like that a pair of rollers are rotated while being in contact with each other. Further, according to this embodiment of the present invention, the cutting mandrel 12 is also rotated at rotational linear velocity vp of the long paper pipe 10.

The apparatus according to the present invention has a structure, wherein the difference of relative velocities between the cutting blade 14 and the long paper pipe 10 is very small and wherein frictional heat is hardly generated when the cutting edge 14A is inserted into the long paper pipe 10 while cutting the same.

The cutting unit 124 is moved along the rail section 122 by predetermined pitches and, at respective positions, is moved toward or away from the long paper pipe 10. This pitch-movement is precisely controlled by AC serve-motor so as to determine a proper position.

Also, as shown in FIG. 6, depending upon such pitch size, a groove 128 in certain width is preformed on the cutting mandrel 12. The width dimension of the groove 128 generally ranges between 0.1 mm and 1.0 mm, often between 0.2 mm and 0.6 mm. In manufacturing, a value ranging between 0.3 mm and 0.5 mm may be frequently set as a target value.

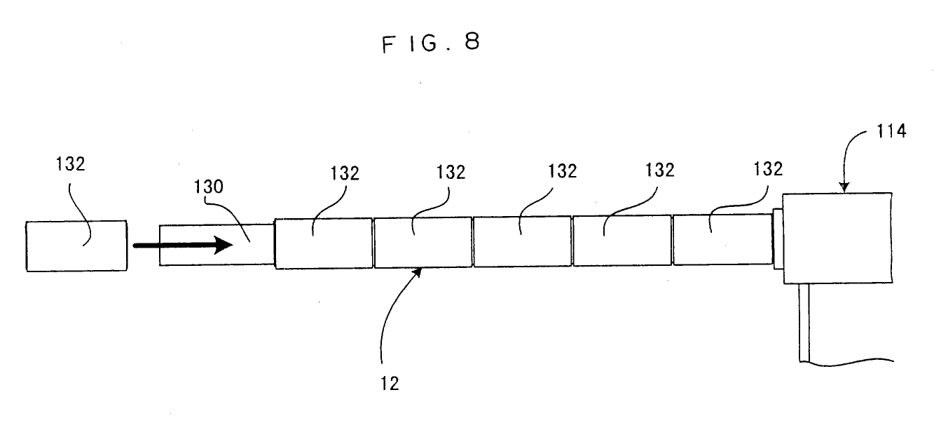

Although the groove 128 is formed integrally with the cutting mandrel 12, it may be formed by drawing a groove 128 in certain depths relative to the cutting mandrel 12. According to one embodiment of the present invention as shown in FIG. 8, the cutting mandrel 12 is constructed to comprise a main pipe 130 and a plurality of mandrel pieces 132 serially inserted around the main pipe 130. In this case, the groove 128 is formed as follows.

An end surface of the mandrel piece 132 is constructed to be of a mortar-shaped recess and a circular protrusion 132A is formed so as to be of a certain radius from an axis of the recess. Since a leading face of the protrusion 132A is slightly protruded relative to an outer peripheral end (in this embodiment, the protruding height is about 0.2 mm), when the mandrel pieces are serially inserted around the main pipe 130, the leading faces of the protrusions 132A become in contact with each other. A gap is generated at the outer peripheral ends of the mandrel pieces 132 by an amount corresponding double the protruding height. The gap can be the groove 128. Since the cutting mandrel 12 can be constructed such that the mandrel pieces 132 are serially inserted around the main pipe 130, upon change of position of the groove 128, it is sufficient to change and insert the mandrel pieces, improving workability of assembly. The long paper pipe 10 can be cut into a plurality of axially short paper pipes 10A by moving the cutting unit 124 by some pitches and accessing the cutting blade 14 toward the long paper pipe 10 by way of driving of the carriage 124B.

Also, after cutting, the carrier 114 of the standby stage 110 is moved away from the main stage 102 along the rail section 112. At this time, the cutting mandrel 12 passes through the through-hole 116 of the partition wall 118 installed between the main stage 102 and the standby stage 110. The paper pipe 10A becomes in contact with the periphery of the through-hole 116 with its end surface and stops moving. Accordingly, the cutting mandrel 12 leaves the paper pipe 10A on the supporting portion 104 and is moved back to the standby stage 110. A blower device, which is not shown in the drawings, is mounted to the partition wall 118 so as to spray air toward the groove 128 of the cutting mandrel 12 to remove cutting waste when the cutting mandrel 12 passes through the through-hole 116 of the partition wall 118.

The paper pipe 10A (a plurality of paper pipes 10A) left on the supporting portion 104 is transferred to the next smoothing process of the paper pipe by inclining the supporting portion 104.

Operation of this embodiment is now described.

The long paper pipe 10 as a raw material is stored in the stock unit 106. When the stopper is released, the foremost long paper pipe 10 rolls along the slope 108 so as to be transferred to the supporting portion 104. Since the supporting portion 104 is of substantially V-shaped portion, cylindrical paper pipe 10 is supported at two points in side-end view. Relative positions to the supporting portion 104 are constantly determined.

When the position of the long paper pipe 10 is determined on the supporting portion 104, the carrier 114 that is on standby at the standby stage 110 is guided along the rail section 112 so as to be moved toward the main stage 102. Accordingly, the cutting mandrel 12 whose one side is supported by the carrier 114 while being suspended is axially moved toward the main stage 102. The cutting mandrel 12 has an axis coaxial with the long paper pipe 10 supported on the supporting portion 104, so that, depending upon the movement of the carrier 114, the cutting mandrel 12 being inserted into the long paper pipe 10.

The outer diameter of the cutting mandrel 12 is almost similar to the inner diameter of the long paper pipe 10 with a certain dimensional tolerance, after inserting of the cutting mandrel into the paper pipe. The outer periphery of the cutting mandrel 12 becomes almost in contact with the inner periphery of the long paper pipe 10.

When the cutting mandrel 12 is completely inserted into the long paper pipe 10, a leading end of the cutting mandrel in axial moving direction and an corresponding end surface of the long paper pipe 10 are sustained on the holding unit 120A of the driving chuck unit 120. After they are sustained by the holding unit 120A, the pressing roller 126 approaches the long paper pipe 10 and a pair of rollers 126A and 126B of the pressing roller become in contact with the long paper pipe 10.

In the driving chuck unit 120, the holding unit 120A is rotated by means of a driving force of the driving section 120B. With this rotation, the cutting mandrel 12 and the long paper pipe 10 are rotated at certain rotational speed.

In this state, the cutting unit 124 is guided along the rail section 122 and returns to its original position, thereby determining exact position. After determination of the position, the cutting blade 14 starts rotating at rotational speed by driving force of the driving section 124A.

The cutting blade 12 approaches the long paper pipe 10 by the carriage 124B so as to cut the long paper pipe 10 at its circumference. At this time, the long paper pipe 10 is pressed against the pressing roller 126 at opposite direction to the cutting blade 14, which prevents an axial deviation of the paper pipe 10.

When the paper pipe is cut by means of the cutting blade 14, the cutting edge 14A is inserted into the paper pipe 10 while cutting the same. At this time, the cutting blade 14 has the thickness t1 ranging from the central axis to certain radial length, the thickness t1 being far thicker than the thickness t2 of the cutting edge 14A-forming circumference. Accordingly, since it is restricted how deep the cutting edge 14A-forming circumference is inserted into the paper pipe 10 while cutting the same, the cutting blade 14 can be basically restricted with its moving distance to a level until the long paper pipe 10 is completely cut (until the cutting edge 14A reaches the inner peripheral face).

In addition, the cutting blade functions as a counter (spindle) for stabilizing rotation through increase of the thickness, so as to restrict rotational deviation in thickness direction upon rotating and driving of the cutting blade 14, thereby minimizing the cutting range upon cutting the long paper pipe 10.

In this case, when the cutting blade 14 approaches the long paper pipe 10 while being rotated at certain rotational speed, the long paper pipe 10 and the cutting mandrel 12 are also rotated at certain rotational speed.

At this time, respective rotational speeds becomes the rotational linear velocity vs of the cutting blade 14 and the rotational linear velocity vp of the paper pipe 10, respectively, and the velocities are almost similar (the difference between the velocities is within certain range) to each other. Also, rotational directions thereof are opposite to each other. Difference in the relative velocities of the cutting blade 14 and the long paper pipe 10 is very little or not generated at all. It is difficult to cause a frictional heat when the cutting edge 14A is inserted into the long paper pipe 10 while cutting the same.

The frictional heat is not caused. This means melting of adhesive from the end surface of the long paper pipe, which is formed by winding thin sheets and applying adhesive between the sheets, and solidification of the adhesive thereto are prevented, thereby avoiding providing the end surface with a gloss by, so called, an ironing effect. The glossing can be also generated by chemical change of the material of the long paper pipe 10, in addition to by the adhesive. Reduction of the frictional heat leads to preventing the chemical change.

Further, the glossing of the end surface caused viscosity of ink to be degraded on information recording process. This problem can be solved by rotating the cutting blade 14 and the long paper pipe 10 in opposite directions to each other at nearly equal rotational linear velocity.

Also, in order to completely cut the long paper pipe 10 up to its inner peripheral face, the cutting edge 14A of the cutting blade 14 has to reach a position beyond the inner peripheral face of the long paper pipe 10. Accordingly, the cutting edge 14A and the cutting mandrel 12 are interfered with each other. In this embodiment, a predetermined width of a groove 128 is previously formed to avoid interfering with the cutting edge 14A. Dimensions of the width of the groove 128 are often in the range from 0.3 mm to 0.5 mm (allowable range is 0.1 mm to 1.0 mm).

The restriction of the width of the groove 128 leads to reducing the amount of burrs to be generated during cutting. Resistance/friction during removing (to be described hereinafter) is eliminated sufficiently when pulling the cutting mandrel 12.

When the cut process using the cutting blade is completed at the initial position, the contact separating carriage 124B returns the cutting blade 14 into the initial position, while the cutting unit 124 is moved into a next cutting position by driving force of the driving section 124A. And then, the cutting blade 14 is reciprocated along the long paper pipe 10 by driving force of the contacting separating carriage 124B to cut the long paper pipe.

By repeating the above process at several times, a plurality of short paper pipes 10A can be obtained from the long paper pipe 10. A remainder may happen to be left at both axial ends of the long paper pipe 10, depending to a dimension of the short paper pipe 10A. For example, if the long paper pipe 10 is 1,600 mm long and a longitudinal direction of the short paper pipe 10A is 152 mm wide, dividing 1,600 by 152 is 10, and the residual is 80 mm. The 40-mm remainder is left at each end. Practically, the dimensions of the short paper pipe 10A may be from 89 mm to 152 mm. Corresponding to these dimensions, the mandrel piece 132, which provides the cutting mandrel 12, is selected and inserted serially into the main pipe 130. A moving pitch of the cutting blade 14 is also set to the dimensions of the short pipe 10A at site.

When all steps of cutting process finish, the plurality of paper pipes 10A are coaxially supported on the cutting mandrel 12. In this state, the carrier 114 of the standby stage 110 is guided to the rail section 112 and moves in a direction of moving away from the main stage 102. As a result, the mandrel 12 gradually starts providing an axial movement from the main stage 102 to the standby stage 110.

Here, the partition wall 118 is arranged between the main stage 102 and the standby stage 110, the mandrel 12 passes through the through-hole 116 formed with the partition wall 118. The paper pipes 10A interfere with a circumferential end of the through-hole 116 and stops its movement. Thus, the mandrel 12 can be extracted from the plurality of the paper pipes 10A.

The extracted paper pipes 10A are each supported on the supporting portion 104, and when the supporting portion 104 is slanted, are transported to next process, i.e., a process of smoothing the paper pipes.

Because the paper pipes 10A, which the paper pipe cutting process has ended as mentioned above, each has a burr generated on an end surface of the inner circumferential side, this burr is removed at the paper pipe smoothing process. In other words, the pair of rotating members 16, each of which has a tapered cutting surface, are each arranged coaxial to each paper pipe 10A on opposite ends of each paper pipe 10A, and cut away the burr while rotating in a direction opposite to the each paper pipe 10A. Further, conventionally, this burr grasped the clearance groove of the cutting blade formed at the mandrel greater than necessary, so that a larger burr was generated. However, in this embodiment, because a width of the groove 128 installed at the mandrel 12 is dimensioned, a trivial burr is generated, and thereby the smoothing process can be subjected to a released load.

The paper pipes 10A free from the burr are sent to an information recording process, and allows information to be recorded/written on its end surface (thick portion).

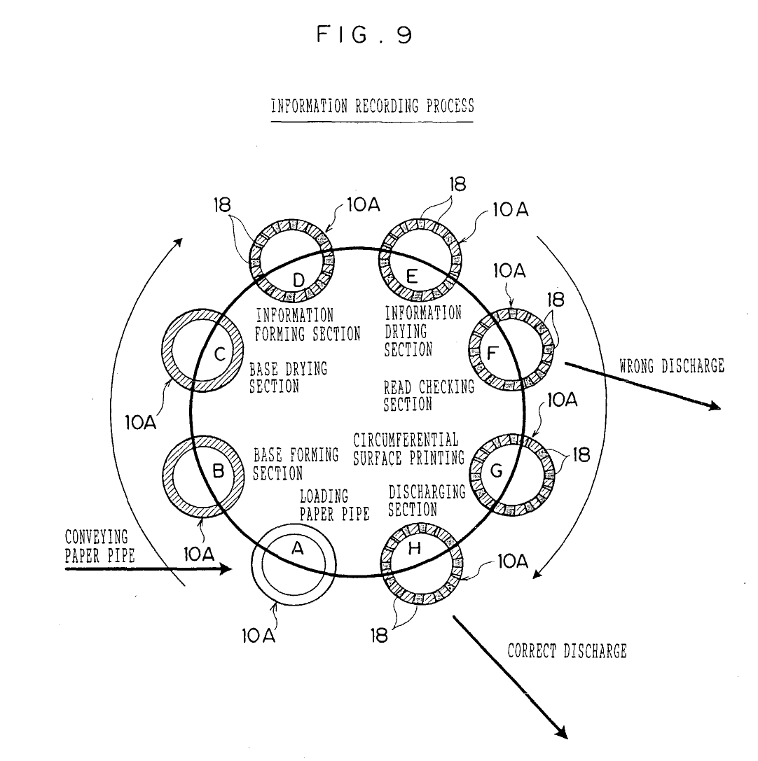

In this embodiment, recording/writing information is carried out in a way that each short paper pipe 10A shown in FIG. 9 is loaded from a lower tangential direction of its own circular movement trajectory, and then rotates and moves throughout eight steps including the charging position.

That is, when each paper pipe 10A is loaded at a loading section A, the ink which does not absorb infrared rays is applied over all the end surface of the paper pipe at the next stop position (base forming section B). Next, moving one step, the base is dried by an infrared heater (base drying section C). Subsequently, in next step, the information is radially recorded/written using the ink which absorbs infrared rays (information forming section D). This information is recorded into a bar code 18, by which type and size of the recording material wound around each paper pipe 10A can be mechanically read in next process.

Further, in next step, the information recorded into the bar code 18 is dried by the infrared heater (information drying section E). In next step, read checking of the formed information is performed (read checking section F). If something wrong in the information is detected, the corresponding paper pipe is discarded in this step. If the information is correctly recorded, it proceeds to next step. In next step, the circumferential surface of the paper pipe 10A is provided with a lot number and so on (circumferential surface recording G). In the final step, the paper pipe 10A is discharged (discharging section H), and then is transported to next process, i.e., a process of winding a recording material. That is, a plurality of recording processes are performed during rotation of about 360° from the loading section A to the discharging section H.

In addition, because the ink which does not absorb infrared rays applied as the base and the ink which absorbs infrared rays used for recording the information (bar code 18) each have a strong concentration of color (nearing approximately black color), it is difficult to discriminate them with a naked eye, but it is possible to read the information under a certain wavelength of light source. On recording/writing with these inks, as mentioned above, the end surfaces of the paper pipe 10A is not subjected to glossification by solidification of the adhesive, the inks have a good viscosity, and thus the information can be firmly recorded.

After the bar code 18 is recorded/written in the information recording process, the recording material 20 is wound around the paper pipe 10A as a core in layers. Winding continues to be a predetermined length. Then the wound recording material 20 is wrapped by a shielding wrapping paper 22 in a wrapping process. Further, after wrapping, the interior of the wounded recording material 20 made to be in a vacuum state. The wrapped roll-type recording material 20 is packed in the corrugated cardboard 24 in the packing process, and then shipped.

As can seen from the foregoing, the present embodiment is designed to make both the rotational linear velocity of the cutting edge 14A of the cutting blade 14 and the rotational linear velocity of the outer circumference (in fact, the thicknesswise middle portion) of the long paper pipe 10 to be approximately equal to each other (to make a difference between velocities to be within a certain range), and to perform cutting during rotation in a direction opposite to each other. Therefore, in theory, the cutting edge 14A is adapted to vertically cut and enter the long paper pipe 10, so that the generation of frictional heat caused by sliding movement between the cutting edge 14A and the long paper pipe 10 is reduced. Owing to the reduction of frictional heat, the adhesive is neither melted nor solidified on the end surface of the paper pipe, and the paper pipe 10A itself does not cause a chemical change to make its end surface to be glossy. As a result, the viscosity of inks used for recording information on the end surface can be improved.

As mention above, the present invention has an excellent effect that it can maintain the permeability of inks for recording the cut face of the paper pipe, so that it can perform a firm recording.

Although an embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for cutting, at an appropriate length, a cylindrical paper pipe serving as a core, around which a long recording material is wound successively in a widthwise direction perpendicular to a winding direction of the recording material, the apparatus comprising:
a cutting mandrel, which is insertable into the paper pipe such that its outer peripheral surface comes into contact with an inner surface of the paper pipe;
a disc-shaped cutting blade positioned opposite to the outer periphery of the paper pipe and having a cutting edges at its circumference;
a ring-shaped groove formed on the cutting mandrel so as to correspond to a cutting position of the cutting blade in the axial direction of the cutting mandrel:
a rotating device for rotating the paper pipe, which is supported by the cutting mandrel; and
a cutting blade rotating device for rotating the cutting blade, wherein a difference between linear rotation velocities of the paper pipe rotating device and the cutting blade rotating device is controlled within a certain range.

2. The apparatus according to claim 1, further comprising a cutting mandrel rotating device, wherein the linear rotation velocity controller controls the respective rotational linear velocities of the cutting mandrel rotating device, the paper pipe rotating device and cutting blade rotating device to be within a certain range.

3. The apparatus according to claim 1, further comprising a pair of rotating members positioned opposite to each other at inner and outer cutting surfaces of the paper pipe cut with the cutting blade, wherein one rotating member rotates in an opposite direction relative to that of the other rotating member and said rotating members have tapered cutting surfaces for smoothing and removing burrs formed on an inner periphery of the paper pipe.

4. The apparatus according to claim 1, further comprising a main stage and a standby stage mounted adjoiningly to the main stage, wherein the standby stage includes a rail section and a carrier supported thereto, wherein the carrier is guided along the rail section, so that the standby stage is movable toward or away from the main stage, and wherein the cutting mandrel is attached to the carrier.

5. The apparatus according to claim 1, wherein the rotational linear velocities of the cutting blade and the paper pipe are controlled to be equal.

6. The apparatus according to claim 2, wherein the paper pipe rotating device and the cutting mandrel rotating device are rotated by a common driving source.

7. The apparatus according to claim 4, wherein the cutting mandrel is positioned coaxially corresponds with the axis of the paper pipe supported on a supporting portion included in the main stage.

8. The apparatus according to claim 7, wherein the paper pipe rotating device includes a driving chuck unit provided on the main stage opposite to the standby stage, wherein the driving chuck unit includes a holder section for holding an end of the paper pipe and a leading edge of the cutting mandrel approaches the paper pipe from the standby stage.

9. The apparatus according to claim 8, wherein the driving chuck unit includes a driving section and the holder section holds the cutting mandrel and the paper pipe to be rotatable by a driving force of the driving section.

10. The apparatus according to claim 8, wherein a rail section is mounted at the main stage from the standby stage to the driving chuck unit, wherein a cutting unit is supported on the rail section, said cutting unit being configured such that it is guided along the rail section and movable from the standby stage to the driving chuck unit, and the cutting blade is fixed upon the cutting unit.

11. The apparatus according to claim 10, wherein a rotational axis of the cutting blade is parallel to axes of the held cutting mandrel and the paper pipe, and is rotatable by the driving section of the cutting unit.

12. The apparatus according to claim 10, wherein the cutting unit is moved along the rail section at intervals and, at respective positions, is moved toward or away from the paper pipe, and depending upon the intervals of the cutting unit, the width of a groove formed on the cutting mandrel ranges between 0.1 mm and 1.0 mm.

13. The apparatus according to claim 11, wherein a thickness-wise dimension of the cutting blade from a central axis is formed so as to be thicker than a thickness-wise dimension of the periphery edge formed by a blade.

14. The apparatus according to claim 12, wherein the width of the groove ranges between 0.2 mm and 0.6 mm.

15. The apparatus according to claim 12, wherein the groove is formed by being carved to a depth corresponding to the cutting mandrel.

16. The apparatus according to claim 12, wherein the cutting mandrel comprises a main pipe and a plurality of mandrel pieces sequentially inserted around the main pipe, each mandrel piece having a mortar-shaped recess on its edge and a circular protrusion, and when the mandrel pieces are sequentially inserted around the main pipe, the leading tips of the protrusions come in contact with each other so that a gap, which serves as the groove, is formed at the outer peripheral ends of the mandrel pieces.

17. The apparatus according to claim 14, wherein the width of the groove ranges between 0.3 mm and 0.5 mm.

18. A method for cutting a cylindrical paper pipe serving as a core, around which a long recording material is wound in layers, in a widthwise direction perpendicular to a winding direction of the recording material, said paper pipe cut to an appropriate length, the method comprising:
rotating a disc-shaped cutting blade such that a cutting mandrel is inserted into the paper pipe with an inner periphery of the paper pipe contacting an outer periphery of the cutting mandrel; and
upon cutting at an axial position of the paper pipe, the paper pipe is cut while being rotated in such a maimer that the difference between rotational linear velocities of the paper pipe and the cutting blade is controlled within a certain range.

19. The method according to claim 18, further comprising forming a ring-shaped groove on the cutting mandrel corresponding to the cutting blade, wherein the groove is formed such that inteference between cutting edges of the cutting blades and the cutting mandrel is avoided when cutting.

20. The method according to claim 18, further comprising controlling the rotational linear velocities of the cutting blade and the paper pipe so as to be equal.
